(19) United States
(12) Patent Application Publication
(10) Pub. No.: US 2003/0171198 A1
(43) Pub. Date: Sep. 11, 2003

(54) Method for producing a deep rolling roller, and deep rolling roller

(76) Inventor: Siegfried Bagusche, Erkelenz (DE)

Correspondence Address: Charles Guttman, Proskauer Rose, 1585 Broadway, New York, NY, 10036, US

(21) Appl. No.: 10/297,014

(22) PCT Filed: Mar. 8, 2002
(86) PCT No.: PCT/EP02/02569

(51) Int. Cl. B25F 5/02; F16C 13/00; B21K 1/02

(52) U.S. Cl. 492/58; 29/895.33

(57) ABSTRACT

The method for the manufacture of a fixed roller (1) for a fixed roller tool for the fixed rolling of radii or recesses on bearing pins and crankpins of crankshafts for motor vehicle engines provides for the following method steps:

Turning of the body of the fixed roller (1) made of tool steel,

Separation of the turned fixed roller (1),

Smooth-rolling of the fixed roller (1) in the area (2) of its greatest circumference,

Hardening of the smooth-rolled fixed roller (1), and

Polishing of the hardened fixed roller (1).

The fixed roller is part of a tool for the fixed rolling of radii or recesses on bearing pins or crankpins of crankshafts for motor vehicle engines. Fixed rollers are among the smallest of those parts which form the complex fixed rolling tool. Conventionally there are two fixed rollers, which are arranged inside an individual fixed roller tool; there are also fixed roller tools, however, which feature only one single fixed roller. The fixed rollers engage directly with the workpiece, a crankshaft or a camshaft. In that situation, under the pressure of the fixed roller force they there exert a local plastic deformation on the workpiece, the scale and depth of which are determined by the shape of the fixed rollers and the fixed roller force. At the same time, residual or self-contained stresses are also incurred in the workpiece. Usually, several fixed roller tools are engaged simultaneously on the same workpiece. In the case of a crankshaft, the number of the fixed roller tools in engagement is determined in accordance with the number of bearing pins or crankpins. In this situation, the whole of the fixed roller tools are arranged in each case in an individual machine. Elements of the fixed roller machine control the movements of the fixed roller tools, while other elements create the fixed roller forces and also control the course of their run over the circumference of the workpiece.

A fixed roller tool of the type referred to, and a method for the manufacture of fixed rollers, have been made known, for example, from U.S. Pat. No. 5,806,184. According to this, a fixed roller is acquired by sawing off a blank from the end of a cylindrical bar made of tool steel. The blank which is sawn off is then hardened and brought into the shape of a fixed roller by grinding. This can then be followed by a second grinding, in order to obtain the desired dimensions of the fixed roller. In any event, the second grinding procedure is effected with a centreless grinding method. In conclusion, the fixed roller, correct in form and dimensions, is polished. The known fixed roller consists of materials from the groups CPM-REX 76, ASP-60M-2 or ASP-60M-4, which are steels manufactured by powder-metallurgical means and feature degrees of hardness of between 63 and 70 Rockwell C. Other tools steels are also used, however.

Other manufacturing methods for the production of fixed rollers by turning on lathes are known to the inventor of the present invention, without such methods, as far as the inventor knows, having hitherto been published. The fixed rollers manufactured by turning also consist of the aforementioned materials and feature the aforementioned degrees of hardness.

The micro structure of the known materials, which predominantly involve sintered metals, is the reason for machining marks occurring on the body of the fixed roller during the shaping of the fixed roller by turning and/or grinding. These markings involve microscopically fine turning grooves, notches, and pores on the surface of the fixed roller, which during later use of the fixed roller as a fixed roller tool subjected to extremely high loads, lead to its failure. In other words, the service lives of fixed rollers regularly determine the failure of the fixed roller tool as a whole, and render its replacement necessary. This, however, incurs downtimes of the fixed roller machine, and so reduces its availability. Experience has shown that, with the failure of a fixed roller tool, by way of precaution all the other fixed roller tools of a fixed roller machine are immediately to be replaced at the same time. The same procedure is adopted in the event of shutdown of fixed roller machines after the expiry of a predetermined operating period, based on experience. The availability of individual fixed roller machines, however, is at the same time a determinant factor in how many fixed roller machines must be operated simultaneously in order to fulfil specified production figures.

In the final analysis, the service lives of fixed roller tools are also influenced by the nature, shape, and the material of the workpieces which are to be processed, such as crankshafts or camshafts for motor vehicle engines.

The object of the present invention derives from the foregoing circumstances, namely to increase of the service life of fixed rollers and to improve the precision of their shape. As an integral part of this, the service life of individual fixed roller tools should be increased at the same time, and the downtime of fixed roller machines reduced. The economic performance of fixed roller operation should be improved as a whole.

The problem is resolved by a manufacturing method for fixed rollers in which:

The body of a fixed roller is pre-shaped by turning, grinding, or laser-forming at the end of a cylindrical bar made of tool steel;

The pre-shaped body of the fixed roller is separated from the end of the bar;

The separated fixed roller is rolled smooth in the area of its greatest circumference and, if appropriate, rolled to the correct dimensions;

The smooth-rolled fixed roller is hardened; and

As a final step, the hardened fixed roller is polished.

With this method, particular significance is attached to the method step of smooth rolling. In this situation, not only are the microscopically small defects on the toroidal surface area of the largest circumference of the fixed roller evened out, i.e. smoothed, but, due to the plastic deformation, the rounding radius of the fixed roller in the area of the greatest diameter is maintained with a higher degree of precision in respect of shape and dimensions than was ever possible hitherto with the known manufacturing methods. In addition to this, sizing rolling can be integrated with the smooth rolling of the fixed roller, by means of which the greatest diameter of the fixed roller is determined. At the same time, the service life of the fixed rollers is perceptibly increased; tool fatigue no longer occurs from the outside inwards, as hitherto, but is manifested, if any, as structural fatigue from the interior of the fixed roller.

Further advantageous embodiments of the manufacturing method and of a fixed roller manufactured according to the invention can be derived from the features of the individual sub-claims. In addition to this, the method can also be applied, in an advantageous embodiment extending beyond that described heretofore, to the guide roller on which, as a rule, two fixed rollers are supported inside a fixed roller tool.

Such a guide roller has on its outer circumference a central projecting collar, which, with the remainder of the body of the guide roller, forms a radius on both sides. The fixed roller is supported on the guide roller in this radius of the guide roller, said radius being adapted to the shape and size of the fixed roller, and is thereby guided. The smooth rolling of this area of the guide rollers can likewise lead to an increase in the service life of both the fixed roller and the guide roller itself.

The invention is described in greater detail hereinafter on the basis of an exemplary embodiment. In each case, in a considerably simplified and approximately to scale representation, the smooth rolling of a fixed roller is shown, with

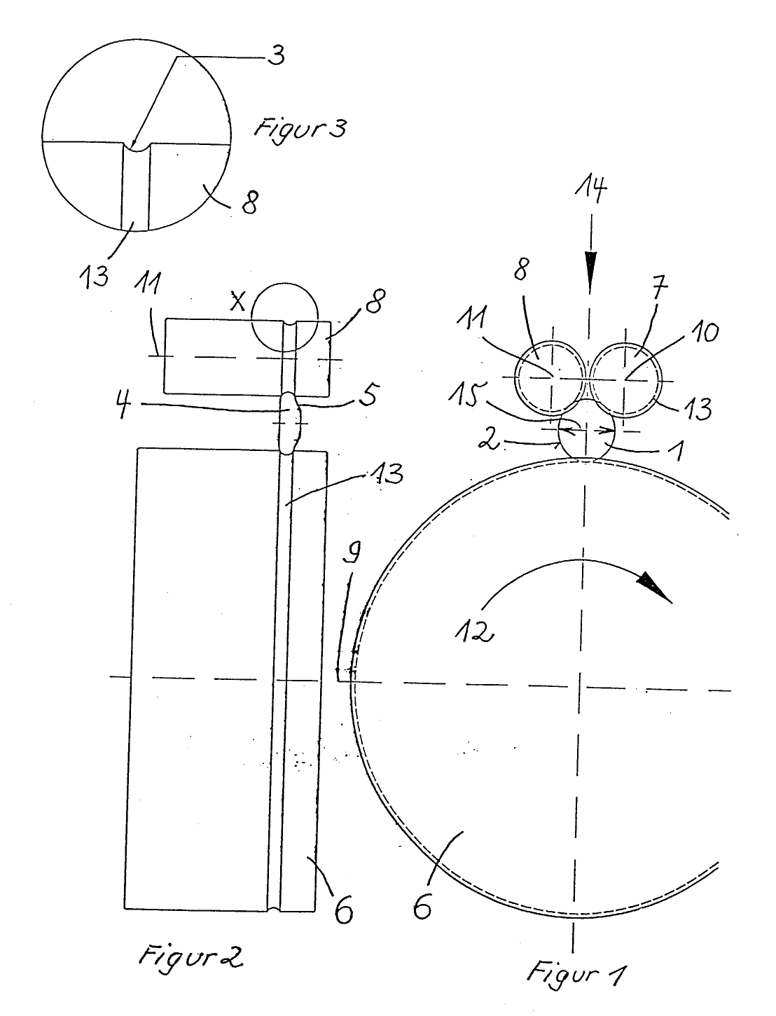

FIG. 1 being a front view,

FIG. 2 a side view, and

FIG. 3 an enlarged section X from FIG. 2.

The fixed roller 1 is a part of an inherently-known fixed roller tool for the fixed rolling of radii or recesses on crankshafts of motor vehicle engines. As can be seen in the example from FIG. 2, the fixed roller 1 has approximately the geometric shape of a truncated cone. In the area 2 of its greatest outer circumference the fixed roller 1 is considerably rounded. The rounding radius of the fixed roller 1 is indicated by the arrow 3 in FIG. 3. As a result of the rounding in the area 2 of the greatest outer circumference, the fixed roller 1 in this area 2 acquires the shape of a torus 4, to which a short truncated cone 5 is connected, in order to circumscribe the outer shape of the fixed roller 1. In addition to this truncated cone shape, however, there are also fixed rollers which tend rather to feature a disk-shaped configuration.

After the preceding shaping, whether by turning, grinding, laser-processing, or a suitable combination of such methods, and the separation from a cylindrical bar of tool steel, the fixed roller 1 is rolled smooth in the area 2 of its greatest outer circumference. To achieve this, it is tensioned, without further guidance, i.e. centreless, between a set of smoothing rollers. The set of planishing rollers consists of the cylindrical smoothing rollers 6, 7, and 8, which, as can be seen from FIG. 1, are arranged in the geometric configuration of a triangle. The smoothing rollers 6, 7, and 8, are in each case capable of being rotated about their longitudinal axes 9, 10, and 11. The largest smoothing roller 6 is capable of being driven and rotates, for example, in the clockwise direction 12.

Each of the three planishing rollers 6, 7, and 8, features a circumferential groove 13, regardless of the individual diameter of the planishing roller 6, 7, or 8. The circumferential groove 13 of all three planishing rollers 6, 7, and 8, are of approximately the same depth and the same rounding radius 3.

During smoothing rolling, the fixed roller 1 is tensioned between the smoothing rollers 6, 7, and 8. In this situation, the smoothing roller 6 rotates in a clockwise direction 12, and causes the other two smoothing rollers 7 and 8 to rotate in sympathy by means of the fixed roller 1 which rotates with it. At the same time, the fixed roller 1 is guided in the circumferential groove 13 of all three smoothing rollers 6, 7, and 8. A smoothing rolling force 14 is applied by means of the two smoothing rollers 7 and 8. Under the effect of the smoothing force 14, the fixed roller 1 is simultaneously rolled smooth by all three of the planishing rollers 6, 7, and 8, in the area 2 of its greatest outer circumference, i.e. it undergoes local plastic deformation. In this situation, any traces of the previous processing and machining present in the area 2 disappear, and the rounding radius 3 of the torus 4 of the fixed roller 1 is adjusted. During sizing rolling, at the same time as the smooth rolling, the predetermined greatest diameter 15 of the fixed roller 1 is set. The smoothing force 14 can also be applied by means of the driven smoothing roller 6, instead of via the smoothing rollers 7 and 8. Instead of the drive by means of the smoothing roller 6 with the greatest diameter, the drive can also be initiated by one or both of the smoothing rollers 7 or 8, which each have a smaller diameter than the smoothing roller 6, as can be seen from FIGS. 1 and 2.

The smooth rolling cycle amounts to only a few rolls over the torus 4. The smoothing force 14 depends on the size and material of the fixed roller 1, and is determined empirically beforehand.

After smooth rolling, the fixed roller 1 is removed by the displacement of at least one of the smoothing rollers 6, 7, or 8 into an opening position. Thereafter, a further fixed roller 1 is introduced between these smoothing rollers 6, 7, and 8, and the previously opened smoothing roller 6, 7, or 8 is brought back into its working position, as represented in FIG. 1. The procedure of clamping and releasing a fixed roller 1 can take place automatically.

The smooth-rolled fixed roller 1 is then hardened.

The smooth-rolled and hardened fixed roller 1 is then conducted to the final method step, polishing. In this step, the entire surface of the fixed roller 1 is hardened and tempered in an inherently known manner. Dimensions and shape of the fixed roller 1 are not changed any further by polishing.

The guide rollers of fixed roller tools can also be processed by analogy with the treatment of fixed rollers 1 as described. To do this, instead of smoothing rollers 6, 7, and 8, provided with circumferential grooves 13, such smoothing rollers are used which have a projecting outer circumference, without this requiring a separate description.

LIST OF REFERENCE NUMBERS

1 Fixed roller

2 Area of greatest outer circumference

3 Rounding radius

4 Torus

5 Truncated cone

6 Smoothing roller

7 Smoothing roller

8 Smoothing roller

9 Longitudinal axis

10 Longitudinal axis

11 Longitudinal axis

12 Direction of rotation

13 Circumferential groove

14 Smoothing force

15 Greatest diameter

1. A method for the manufacture of fixed rollers (1), characterised by the following method steps:
a) Preforming of the body of a fixed roller (1) by turning at the end of a cylindrical bar of tool steel,
b) Cutting off the pre-formed fixed roller (1) from the end of the bar,
c) Smooth rolling of the fixed roller (1) in the area (2) of its largest circumference,
d) Hardening of the smooth-rolled fixed roller (1), and
e) Polishing of the hardened fixed roller (1).

2. The method according to claim 1, characterised in that, by smooth rolling the fixed roller (1), the curvature radius (3) is determined in the area (2) of its greatest circumference.

3. The method according to claim 2, characterised in that, by sizing rolling in the course of the smooth rolling, the greatest diameter (15) of the fixed roller (1) is determined.

4. The method according to claim 1 or 2, characterised in that the fixed roller (1) is hardened by heat treatment to a degree of hardness of between 60 and 70 Rockwell C.

5. The method according to claim 1 or 2, characterised in that the fixed roller (1) is smooth-rolled, centreless, between three smoothing rollers (6, 7, and 8).

6. A fixed roller (1) for a fixed roller tool for the fixed rolling of radii or recesses on the main bearings or connecting-rod bearings of crankshafts of motor vehicles with an approximately truncated-cone shaped body, which is formed by metal-removing forming at the end of a cylindrical bar of tool steel, and is hardened and polished, characterised in that:
The body of the fixed roller (1) is a turned part, and
It is smooth-rolled in the area (2) of its greatest outer circumference.

7. The fixed roller according to claim 6, characterised in that it consists of tool steel manufactured by powder metallurgy.

8. The fixed roller according to one of claims 6 or 7, characterised in that it features a degree of hardness of between 60 and 70 Rockwell C.
